(19) United States
(12) Patent Application Publication
(10) Pub. No.: US 2010/0128593 A1
(43) Pub. Date: May 27, 2010

(54) PHASE DIFFERENCE ELEMENT AND OPTICAL HEAD APPARATUS

(75) Inventors: Koichi Murata, Tokyo (JP); Toshimasa Kakiuchi, Koriyama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Tokyo (JP)

(21) Appl. No.: 12/694,548

(22) Filed: Jan. 27, 2010

Related U.S. Application Data
(63) Continuation of application No. PCT/JP2008/063346, filed on Jul. 25, 2008.

(30) Foreign Application Priority Data
Jul. 27, 2007 (JP) 2007-195796

(51) Int. Cl. G11B 7/135; G02B 27/28

(52) U.S. Cl. 369/112.23; 359/487; G9B/7.097

(57) ABSTRACT

Three phase difference layers having refractive index anisotropy are stacked in parallel and an optic axis angle and retardation of each of the phase difference layers are adjusted and thereby, characteristics having peaks at which ellipticity is approximated to 1 at desired three design wavelengths can be obtained and it can efficiently be adapted to an optical head apparatus for converting linear polarization of a light source with, for example, three different wavelengths into circular polarization.

### TECHNICAL FIELD

The present invention relates to a phase difference element for changing a polarization state of light, and an optical head apparatus for making recording or reproduction with respect to an optical recording medium (hereinafter called an optical disk) such as a CD, a DVD, a Blue-ray disk (hereinafter called a BD) or an HD-DVD.

### BACKGROUND ART

This kind of optical head apparatus comprises a light source and an optical detector, an optical path separation element such as a beam splitter for reflecting an optical beam emitted from the light source so as to guide the optical beam to an optical disk and also transmitting reflected light from the optical disk so as to guide the reflected light toward the optical detector, and an objective lens arranged oppositely to an information recording surface of the optical disk. Particularly, a quarter-wave plate (λ/4 plate) for rotating a polarization plane of light incident on and reflected by the optical disk, that is, changing a polarization state of light is generally disposed between the objective lens and the optical path separation element. Here, the “polarization state” of light in the invention of the present application refers to circular polarization, linear polarization or elliptical polarization, and also refers to a direction of the long axis of its electric field in the case of the linear polarization or the elliptical polarization.

The quarter-wave plate used as a normal phase difference element can develop a phase difference of a quarter-wavelength with respect to light of a particular wavelength and convert light of linear polarization into light of circular polarization (or light of circular polarization into light of linear polarization), but with respect to light of linear polarization of a wavelength different from its wavelength, a phase difference deviates from a quarter-wavelength, so that conversion into circular polarization cannot be made. In this case, for example, an optical head apparatus for recording or reproducing an optical disk with plural standards has a light source with plural wavelengths, so that it is necessary to respectively comprise quarter-wave plates according to light of the plural wavelengths and a disadvantage occurred in cost reduction and miniaturization of the apparatus.

Ellipticity can be made higher than that of light of the other wavelength with respect to light of particular two wavelengths, in other words, approximation to circular polarization can be made by comprising a broadband wavelength plate of a configuration using two phase difference layers, for example, in the case of light of two kinds of wavelengths (wavelengths of bands of 660 nm and 780 nm for DVD and CD) in order to implement a function of a quarter-wave plate by one phase difference element with respect to light of plural wavelengths until now (Patent Reference 1). Also, a quarter-wave plate of a wider range of wavelength which is constructed by a wavelength plate of three layers and expands a wavelength range with large ellipticity is reported (Patent Reference 2). In addition to this, a wavelength plate for approximating ellipticity to 1 at a pinpoint in wavelengths of 400 nm, 650 nm and 785 nm using two phase difference layers is reported (Patent Reference 3).

Patent Reference 1: JP-A-2001-101700

Patent Reference 2: JP-A-2006-114080

Patent Reference 3: JP-A-2007-086105

### DISCLOSURE OF THE INVENTION

### Problem that the Invention is to Solve

However, in both of Patent Reference 1 and Patent Reference 2, a peak at which ellipticity in a particular wavelength range is approximated to 1 is two points and when these broadband wavelength plates are applied to a recent optical head apparatus, the peak at which ellipticity is approximated to 1 cannot be had at all the three wavelength bands of a band of 780 nm for CD, a band of 660 nm for DVD and a band of 405 nm for BD or HD-DVD. In other words, in the case of giving the peaks to ellipticities of the band of 405 nm and the band of 660 nm, the peak is absent in ellipticity of the band of 780 nm and the ellipticity also becomes relatively low. As a result of this, the optical head apparatus having such three light sources had a problem of causing a decrease in a utilization ratio of light in light of any wavelength. Also, Patent Reference 3 has characteristics of becoming a peak at which ellipticity is approximated to 1 according to wavelengths of three light sources for optical head apparatus, but when a wavelength of the pinpoint light source fluctuates or only deviates from a predetermined wavelength by about 10 nm due to variations in the light source, ellipticity reduces largely and it becomes difficult to make conversion into circular polarization, so that there was a problem in reliability or manufacturing variations.

The invention has been implemented in order to solve such problems, and an object of the invention is to provide a phase difference element having three or more peaks at which ellipticity approximates to 1 when light of linear polarization enters in a predetermined wavelength range (380 to 900 nm) and also having constant ellipticity even at a wavelength other than the peaks.

### Means for Solving the Problem

The invention provides a phase difference element for changing a polarization state of incident light incident by light of linear polarization of three or more different wavelengths λₖ (k=1, 2, 3, . . . ) and transmitting the light, wherein the phase difference element is constructed of three phase difference layers respectively arranged in parallel in order of a first phase difference layer, a second phase difference layer and a third phase difference layer having refractive index anisotropy from the incident light side, and a fast axis direction of the second phase difference layer differs from fast axis directions of the first phase difference layer and the third phase difference layer, and ellipticity of light transmitted through the phase difference element, the light in which ellipticity at a wavelength band of λₖ±Δλₖ at the time of setting Δλₖ at 3% of the wavelength λₖ becomes 0.6 or more, changes by a wavelength of the transmitted light, and retardations of the respective three phase difference layers and angles of optic axis directions of the respective three phase difference layers are adjusted so as to have peaks at which the ellipticity approximates to 1 at the three or more wavelengths.

By this configuration, one phase difference element can be made to function as a high-quality quarter-wave plate with respect to light of three different wavelengths.

Also, the invention provides the phase difference element wherein light of linear polarization of three different wavelengths λₖ (k=1, 2, 3) enters the phase difference element and peaks at which the ellipticity approximates to 1 are had at the three different wavelengths and also the amount of change in ellipticity at the time when a wavelength changes by 1% is within 0.1 at a wavelength band of λₖ±Δλₖ at the time of setting Δλₖ at 3% of the wavelength λₖ.

By this configuration, even in the case of entering a phase difference element in the presence of fluctuation in light of a predetermined wavelength, modulation can be performed without reducing ellipticity of linear polarization, so that reliability improves and this is preferable. In the case of doing design so that a difference in ellipticity is within 0.1 when Δλₖ is set at 2% of the wavelength λₖ, even when a range of fluctuation in the wavelength is large, a big change in ellipticity is absent and this is more preferable.

Also, the invention provides the phase difference element wherein when light of the three wavelengths λ₁, λ₂ and λ₃ is entered by light of linear polarization becoming the same polarization direction and values of Stokes parameters indicating a polarization state of light incident on the third phase difference layer are respectively set at (S₁₃₁, S₂₃₁, S₃₃₁) (S₁₃₂, S₂₃₂, S₃₃₂) and (S₁₃₃, S₂₃₃, S₃₃₃) with respect to the three wavelengths λ₁, λ₂ and λ₃, values of B₁, B₂ and B₃ satisfying the following equalities are substantially equal.

S₂₃₁=B₁×S₁₃₁,

S₂₃₂=B₂×S₁₃₂, and

S₂₃₃=B₃×S₁₃₃.

By doing design thus, with respect to Stokes parameters of light of linear polarization incident, a setting condition of a first phase difference layer and a second phase difference layer among conditions of an optic axis angle and retardation of each of the phase difference layers for changing Stokes parameters of light transmitted through a phase difference element into a state of circular polarization can be defined.

Also, the invention provides the phase difference element wherein when light of the three wavelengths λ₁, λ₂ and λ₃ is entered by light of linear polarization becoming the same polarization direction and values of Stokes parameters indicating a polarization state of light incident on the second phase difference layer are respectively set at (S₁₂₁, S₂₂₁, S₃₂₁), (S₁₂₂, S₂₂₂, S₃₂₂) and (S₁₂₃, S₂₂₃, S₃₂₃) with respect to the three wavelengths λ₁, λ₂ and λ₃, values of A₁, A₂ and A₃ satisfying the following equalities are substantially equal.

(S₂₃₁−S₂₂₁)=A₁×(S₁₃₁−S₁₂₁),

(S₂₃₂−S₂₂₂)=A₂×(S₁₃₂−S₁₂₂), and

(S₂₃₃−S₂₂₃)=A₃×(S₁₃₃−S₁₂₃).

By doing design thus, with respect to Stokes parameters of light of linear polarization incident, a setting condition of a first phase difference layer and a second phase difference layer among conditions of an optic axis angle and retardation of each of the phase difference layers for changing Stokes parameters of light transmitted through a phase difference element into a state of circular polarization can be defined further and a third phase difference layer can be set after this condition is satisfied.

Also, the invention provides the phase difference element wherein the λ₁ is between 380 and 450 nm and the λ₂ is between 600 and 720 nm and the λ₃ is between 750 and 900 nm.

By this configuration, it functions as a quarter-wave plate at all the wavelength bands of light standardized for pickup of an optical disk, so that substitution of plural phase plates is enabled.

Also, the invention provides the phase difference element wherein ellipticities of the transmitted light in which light of the three wavelengths λ₁, λ₂ and λ₃ is transmitted through the phase difference element are respectively 0.9 or more.

By this configuration, a function as a quarter-wave plate at each of the wavelengths can be satisfied sufficiently, so that a decrease in light use efficiency can be suppressed.

Also, the invention provides an optical head apparatus having a light source with three different wavelengths, an objective lens for collecting light emitted from the light source in an optical disk, and an optical detector for detecting reflected light from the optical disk, characterized in that a phase difference element described above is arranged in an optical path ranging from a light source to an optical detector.

By this configuration, it can be adapted as a quarter-wave plate in all the light of three kinds of different wavelengths used for pickup of three kinds of standardized optical disks applied to an optical head apparatus. As a result of this, by using one phase difference element for the optical head apparatus in which the three kinds of optical disks are compatible, it can be adapted to light of all the wavelength bands and miniaturization and cost reduction can be achieved.

### ADVANTAGE OF THE INVENTION

The invention can provide a phase difference element which is constructed by stacking three phase difference layers having refractive index anisotropy in parallel and functions as a quarter-wave plate for converting all the light of linear polarization of three or more different wavelengths into circular polarization by adjusting an optic axis angle and retardation of each of the phase difference layers.

### BRIEF DESCRIPTION OF THE DRAWINGS

FIG. 1 is a sectional schematic diagram showing a configuration of a phase difference element of the invention.

FIG. 2 is a schematic diagram showing an optic axis direction and incident light of the phase difference element of the invention.

FIG. 3 is a characteristic diagram of ellipticity with respect to a wavelength of light passing through the phase difference element of the invention.

FIG. 4 is a transition diagram of Stokes parameters in a first design example of the invention.

FIG. 5 is a transition diagram of Stokes parameters in a third design example of the invention.

FIG. 6 is a transition diagram of Stokes parameters in a fourth design example of the invention.

FIG. 7 is a conceptual diagram of an optical head apparatus equipped with the phase difference element of the invention.

### DESCRIPTION OF REFERENCE NUMERALS AND SIGNS

1 phase difference element
2 incident light (linear polarization)
3 transmitted light (circular polarization)
11 first phase difference layer
12 second phase difference layer
13 third phase difference layer
20 polarization direction of incident light
21 first phase difference layer optic axis (fast axis)
22 second phase difference layer optic axis (fast axis)
23 third phase difference layer optic axis (fast axis)
100 optical head apparatus
101,102,103 semiconductor laser light source
104,105 wave combination prism
106 collimator lens
107 polarization beam splitter
108 objective lens
109 optical disk
110 optical detection system

### BEST MODE FOR IMPLEMENTING THE INVENTION

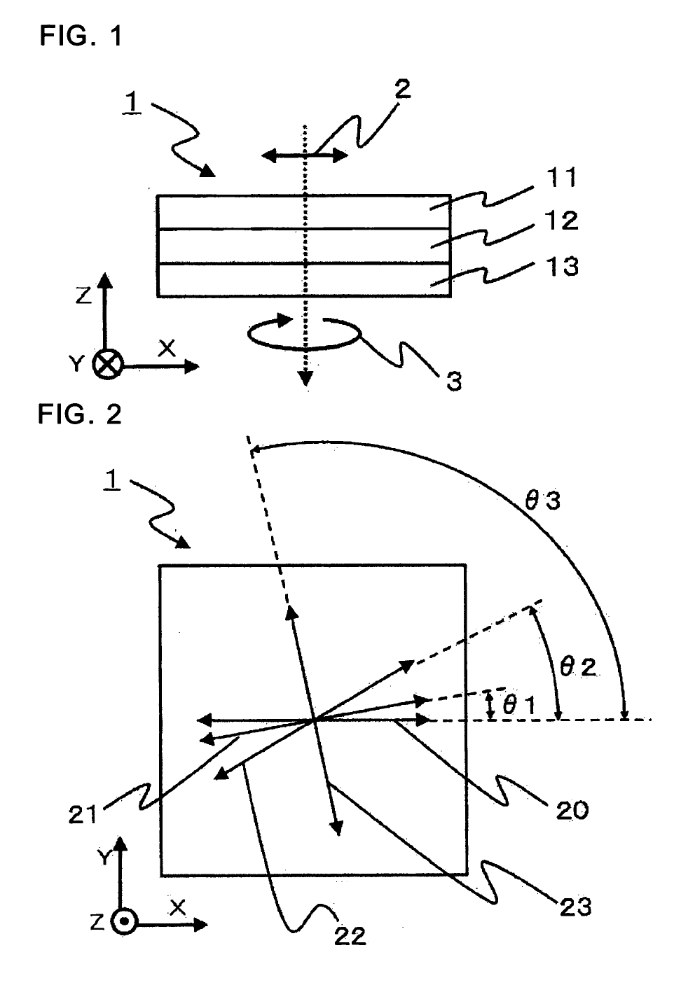

FIG. 1 shows a schematic diagram of a sectional structure of a phase difference element 1 according to the present embodiment. The phase difference element 1 is constructed of three phase difference layers of a first phase difference layer 11, a second phase difference layer 12 and a third phase difference layer 13 made of a material having refractive index anisotropy from the side in which light of linear polarization is entered. These phase difference layers have an integrated configuration by laminating the layers through an adhesive layer or a sticky layer or fusing or welding the layers and thereby, the number of components reduces and laminating accuracy improves and characteristics of the phase difference element are stable. Also, when the layers can be laminated substantially even in the absence of the adhesive layer, further miniaturization can be achieved and this is preferable. Also, these phase difference layers may be laminated on a transparent substrate, or the phase difference layer may be pinched by a transparent substrate such as glass or a transparent resin, or a transparent substrate may be pinched between the two phase difference layers. Further, integration by laminating the phase difference element of the invention to other phase difference elements or laminating the phase difference element on a prism, a diffractive element, etc. is preferable for a similar reason.

As a material of the phase difference layer, a polymer liquid crystal in which a liquid crystal is polymerized, a liquid crystal, an optical anisotropic single crystal such as KDP, LiTaO₃, LiNbO₃ or a quartz crystal, or a material in which a resin film such as PVA, polyolefin or polycarbonate is stretched can also be used. In addition to that, the material is not limited to the above as long as the material has the refractive index anisotropy. Also, it is unnecessary for the three phase difference layers to have the same material, and materials may be combined properly.

Here, light of linear polarization parallel to the X axis of FIG. 1 enters the phase difference element 1 in a straight-ahead direction of the Z axis perpendicular to an X-Y plane. FIG. 2 is a schematic diagram viewed from the X-Y plane of the phase difference element 1, and angles to optic axes of the phase difference layers are set with reference to a linear polarization direction 20 of incident light. At this time, an angle between an azimuth of the optic axis of the first phase difference layer 11 and the polarization direction 20 of the incident light is set at θ₁, and an angle between an azimuth of the optic axis of the second phase difference layer 12 and the polarization direction 20 is set at θ₂, and an angle between an azimuth of the optic axis of the third phase difference layer 13 and the polarization direction 20 is set at θ₃. Here, the optic axes are described as a fast axis direction conveniently, but all the optic axes may be a slow axis direction of the phase difference layer. Also, retardations of the first phase difference layer 11 with respect to wavelengths λ₁, λ₂ and λ₃ of three different incident lights are respectively set at Rd₁₁, Rd₁₂ and Rd₁₃ (nm), and retardations of the second phase difference layer 12 are respectively set at Rd₂₁, Rd₂₂ and Rd₂₃ (nm), and retardations of the third phase difference layer 13 are respectively set at Rd₃₁, Rd₃₂ and Rd₃₃ (nm). Here, the retardation is expressed by the product Δn·d of refractive index anisotropy Δn of the phase difference layer with respect to a polarization direction of incident light and a thickness (optical path length) d of the phase difference layer.

The retardation of the phase difference layer has wavelength dispersion characteristics different by a material used, but the case where the following equalities in which wavelength dependence (wavelength dispersion of a refractive index) of the retardation of each of the phase difference layers is absent hold is first considered in order to simplify explanation.

Rd₁₁=Rd₁₂=Rd₁₃=Rd₁,

Rd₂₁=Rd₂₂=Rd₂₃=Rd₂, and

Rd₃₁=Rd₃₂=Rd₃₃=Rd₃.

At this time, Rd₁, Rd₂ and Rd₃ are typical retardation values of the respective phase difference layers.

A phase difference element in which light of linear polarization with three different wavelengths of λ₁=405 nm, λ₂=660 nm and λ₃=780 nm respectively enters and light of each of the wavelengths is converted into circular polarization is designed. An azimuth angle of linear polarization at this time is parallel to the X axis in FIG. 2 and a polarization azimuth angle at this time is set at 0°. It is arranged so that the optic axes of the respectively adjacent phase difference layers of the three phase difference layers constructing the phase difference element 1 are different (θ₁≠θ₂, θ₂≠θ₃) as shown in FIG. 2.

A design method of the invention will be described in detail. A design wavelength at which ellipticity is approximated to 1 is set at λₖ (k=1, 2, 3), and a phase difference layer is set at the jth phase difference layer (j=1, 2, 3) from the incident side of light to the phase difference element. A Stokes parameter S is used for indicating a polarization state of light and is normally expressed by a four-dimensional vector of (S₀, S₁, S₂, S₃). S₀, S₁, S₂ and S₃ refer to luminance of light, intensity of polarization of 0°, intensity of polarization of 45′ and intensity of circular polarization, respectively, and the Stokes parameter will hereafter be described as a three-dimensional vector of (S₁, S₂, S₃) by omitting the intensity S₀ of polarization.

The Stokes parameter indicating a polarization state of light in the case of considering a phase difference layer (j) and a kind (k) of a wavelength is first set at (S₁ⱼₖ, S₂ⱼₖ, S₃ⱼₖ). Also, the Stokes parameter of each wavelength after passing through the phase difference element 1 is set at (S₁ₒᵤₜₖ, S₂ₒᵤₜₖ, S₃ₒᵤₜₖ) as shown in Table 1. All the lights of the three design wavelengths λₖ shall enter the phase difference element 1 by light of linear polarization of the same direction (X-axis direction) and the Stokes parameter of incident light of each wavelength becomes (S₁ₖ₁, S₂ₖ₁, S₃ₖ₁)=(1, 0, 0). All the three design wavelengths are described as a state of entering the phase difference element 1 by light of linear polarization of the same direction, but may be in a state orthogonal mutually or a state of entering at a particular angle.

TABLE 1

| | λ₁ (405 nm) | | | λ₂ (660 nm) | | | λ₃ (780 nm) | | |
|---|---|---|---|---|---|---|---|---|---|
| | S₁ | S₂ | S₃ | S₁ | S₂ | S₃ | S₁ | S₂ | S₃ |
| Light incident on first phase | S₁₁₁ | S₂₁₁ | S₃₁₁ | S₁₁₂ | S₂₁₂ | S₃₁₂ | S₁₁₃ | S₂₁₃ | S₃₁₃ |
| difference layer | | | | | | | | | |
| Light incident on second | S₁₂₁ | S₂₂₁ | S₃₂₁ | S₁₂₂ | S₂₂₂ | S₃₂₂ | S₁₂₃ | S₂₂₃ | S₃₂₃ |
| phase difference layer | | | | | | | | | |
| Light incident on third phase | S₁₃₁ | S₂₃₁ | S₃₃₁ | S₁₃₂ | S₂₃₂ | S₃₃₂ | S₁₃₃ | S₂₂₃ | S₃₃₃ |
| difference layer | | | | | | | | | |
| Light transmitted through | S₁ₒᵤₜ₁ | S₂ₒᵤₜ₁ | S₃ₒᵤₜ₁ | S₁ₒᵤₜ₂ | S₂ₒᵤₜ₂ | S₃ₒᵤₜ₂ | S₁ₒᵤₜ₃ | S₂ₒᵤₜ₃ | S₃ₒᵤₜ₃ |
| phase difference element | | | | | | | | | |

A value of each of the Stokes parameters of Table 1 is obtained by a method described below so that light of linear polarization of the design wavelength λₖ passes through the phase difference element 1 and becomes light of circular polarization. Table 2 respectively shows concrete values of the Stokes parameters of transmitted light and light incident on the phase difference layers. The light of circular polarization is set so that S₁ₒᵤₜₖ and S₂ₒᵤₜₖ which are linear polarization components respectively become 0 and S₃ₒᵤₜₖ which is a circular polarization component becomes +1 or −1. In an example of Table 2, S₃ₒᵤₜₖ is +1 and a polarization state is clockwise circular polarization. The “circular polarization” shall hereafter be the clockwise circular polarization unless otherwise specified.

TABLE 2

| | λ₁ (405 nm) | | | λ₂ (660 nm) | | | λ₃ (780 nm) | | |
|---|---|---|---|---|---|---|---|---|---|
| | S₁ | S₂ | S₃ | S₁ | S₂ | S₃ | S₁ | S₂ | S₃ |
| Light incident on first | 1.000 | 0.000 | 0.000 | 1.000 | 0.000 | 0.000 | 1.000 | 0.000 | 0.000 |
| phase difference layer | | | | | | | | | |
| Light incident on second | 0.918 | 0.305 | −0.253 | 0.871 | 0.482 | 0.097 | 0.887 | 0.420 | 0.190 |
| phase difference layer | | | | | | | | | |
| Light incident on third | −0.240 | 0.752 | −0.613 | −0.298 | 0.933 | 0.200 | −0.277 | 0.870 | 0.407 |
| phase difference layer | | | | | | | | | |
| Light transmitted through | 0.000 | 0.000 | 1.000 | 0.000 | 0.000 | 1.000 | 0.000 | 0.000 | 1.000 |
| phase difference element | | | | | | | | | |

Retardation and an optic axis angle of each of the phase difference layers are set in order to change a polarization state (1, 0, 0) of incident light of the design wavelength λₖ to circular polarization with ellipticity=1 of (0, 0, 1). For example, a polarization state of light after passing through each of the phase difference layers becomes the Stokes parameters as shown in Table 2 by being based on the proper retardation and optic axis angle of each of the phase difference layers. A first design guide for guiding such concrete values will be described.

(First Design Guide)

FIG. 4 shows two-dimensional space in which an S₁ component of the Stokes parameters is the axis of abscissa and an S₂ component is the axis of ordinate. Design is first done so that a point of (S₁, S₂)=(0, 0) and each of the points of (S₁₃₁, S₂₃₁), (S₁₃₂, S₂₃₂) and (S₁₃₃, S₂₃₃) indicating polarization states after passing through the first phase difference layer 11 and the second phase difference layer 12 (light incident on the third phase difference layer 13) are positioned in a straight line. In this manner, a condition is adjusted so that optic axis angles and retardations of the first phase difference layer 11 and the second phase difference layer 12 are adjusted and ellipticity after passing through the third phase difference layer 13 becomes 1 with the adjusted condition.

In FIG. 4, coordinates of (S₁₃₁, S₂₃₁), (S₁₃₂, S₂₃₂) and (S₁₃₃, S₂₃₃) are considered. At this time, a condition that values of constants B₁, B₂ and B₃ satisfying the following are substantially equalized is found as the first design guide.

S₂₃₁=B₁×S₁₃₁,

S₂₃₂=B₂×S₁₃₂, and

S₂₃₃=B₃×S₁₃₃.

By this, four points including the point of (S₁, S₂)=(0, 0) are positioned in substantially a straight line.

Concretely, in the values of B₁, B₂ and B₃, values of arctan(B₁), arctan(B₂) and arctan(B₃) preferably match within ±15°. The values more preferably match within ±5°, and furthermore preferably match within ±2°. When numerical values of Table 2 are adapted, the following are satisfied and B₁, B₂ and B₃ are substantially equal and the values of arctan (B₁), arctan(B₂) and arctan(B₃) are also within ±2°.

B₁=S₁₃₁/S₂₃₁=−0.240/0.752=−0.319,

B₂=S₁₃₂/S₂₃₂=−0.298/0.933=−0.319, and

B₃=S₁₃₃/S₂₃₃=−0.277/0.870=−0.318.

Also, when there is no condition that ellipticity approximates to 1 at all the three design wavelengths λ₁, λ₂ and λ₃ even in the case of adjusting an optic axis angle or retardation of the third phase difference layer 13, optic axis angles or retardations of the first phase difference layer 11 and the second phase difference layer 12 are adjusted under the condition that values of B₁, B₂ and B₃ become equal again. Then, the phase difference element of the invention can be designed by doing a repeat so that a condition of the third phase difference layer 13 is adjusted and ellipticity after passing through the phase difference element approximates to 1 at the three design wavelengths.

(Second Design Guide)

Further, a second design guide will be described in detail using FIG. 4 in order to facilitate design. At each of the points of (S₁₂₁, S₂₂₁), (S₁₂₂, S₂₂₂) and (S₁₂₃, S₂₂₃) indicating polarization states after passing through the first phase difference layer 11 (light incident on the second phase difference layer 12) and (S₁₃₁, S₂₃₁), (S₁₃₂, S₂₃₂) and (S₁₃₃, S₂₃₃) indicating polarization states after passing through the second phase difference layer 12 (light incident on the third phase difference layer 13), the points of light of the same design wavelength λₖ are connected each other. In FIG. 4, three vectors corresponding to three wavelengths λₖ (k=1, 2, 3) can be represented, and optic axis angles and retardations of the first and second phase difference layers are designed so that the vectors are parallel.

In FIG. 4, the three vectors become parallel by substantially equalizing values of constants A₁, A₂ and A₃ satisfying the following, respectively.

(S₂₃₁−S₂₂₁)=A₁×(S₁₃₁−S₁₂₁),

(S₂₃₂−S₂₂₂)=A₂×(S₁₃₂−S₁₂₂), and

(S₂₃₃−S₂₂₃)=A₃×(S₁₃₃−S₁₂₃).

Concretely, in the values of A₁, A₂ and A₃, values of arctan(A₁), arctan(A₂) and arctan(A₃) preferably match within ±15°. The values more preferably match within ±5°, and furthermore preferably match within ±2°. When numerical values of Table 2 are adapted, the following are satisfied and A₁, A₂ and A₃ are substantially equal and the values of arctan (A₁), arctan (A₂) and arctan (A₃) are also within ±2°.

A₁=(S₂₃₁−S₂₂₁)/(S₁₃₁−S₁₂₁)=(0.752−0.305)/(−0.240−0.918)=0.447/(−1.158)=0.386,

A₂=(S₂₃₂−S₂₂₂)/(S₁₃₂−S₁₂₂)=(0.933−0.482)/(−0.298−0.871)=0.451/(−1.169)=0.386, and

A₃=(S₂₃₃−S₂₂₃)/(S₁₃₃−S₁₂₃)=(0.870−0.420)/(−0.277−0.887)=0.450/(−1.164)=0.387.

Thus, design can be done as described above, and the phase difference element 1 of the invention can be designed by doing a repeat so that a condition of the third phase difference layer 13 is adjusted and ellipticity after passing through the phase difference element approximates to 1 at the three design wavelengths after optic axis angles or retardations of the first phase difference layer 11 and the second phase difference layer 12 are adjusted under the conditions of the first design guide and the second design guide again when ellipticity does not approximate to 1 at all the three design wavelengths λ₁, λ₂ and λ₃ even in the case of adjusting an optic axis angle or retardation of the third phase difference layer 13. As a common design principle, when ellipticity is approximated to 1 according to the design principle at the three design wavelengths, a condition that ellipticity becomes 0.9 or more at all the design wavelengths is obtained and when its condition is not reached, a condition is again changed and recalculation is repeated.

Here, the first design guide is described independently of the second design guide, but the phase difference element 1 of the invention can be designed more easily by doing a repeat so that an optic axis angle and retardation of the third phase difference layer 13 are adjusted and ellipticity after passing through the phase difference element approximates to 1 at the three design wavelengths after optic axis angles and retardations of the first phase difference layer 11 and the second phase difference layer 12 are designed so as to simultaneously satisfy substantially equalization of values of constants B₁, B₂ and B₃ satisfying the following which are a relation of the Stokes parameters shown in the first design guide,

S₂₃₁=B₁×S₁₃₁,

S₂₃₂=B₂×S₁₃₂, and

S₂₃₃=B₃×S₁₃₃,

and substantially equalization of values of constants A₁, A₂ and A₃ satisfying the following which are a relation of the Stokes parameters described in the second design guide.

(S₂₃₁−S₂₂₁)=A₁×(S₁₃₁−S₁₂₁),

(S₂₃₂−S₂₂₂)=A₂×(S₁₃₂−S₁₂₂), and

(S₂₃₃−S₂₂₃)=A₃×(S₁₃₃−S₁₂₃).

(Third Design Guide)

Further, a third design guide will be described in order to facilitate design. A ratio between retardations of any two of phase difference layers among retardations of three phase difference layers is limited between 1.5 and 2.5 and thereby, a design solution can be obtained more easily, so that this is preferable. The ratio is more preferably limited between 1.8 and 2.2. Concretely, as a limit of an initial value at the time of starting design, a value of Rd₁/Rd₃ is set at 2. Each of the retardations or the optic axis angles is adjusted based on the first design guide or the second design guide described above. As a limit condition in the case of adjustment, Rd₁/Rd₃ is set at 1.8 to 2.2.

(First Design Example)

Angles (θ₁, θ₂, θ₃) of an optic axis direction and retardations (Rd₁, Rd₂, Rd₃) of each of the phase difference layers are adjusted so that light transmitted through each of the phase difference layers becomes a polarization state shown by the Stokes parameters expressed by the coordinates of, for example, FIG. 4 thus. By setting the retardations and the angles as follows in the first and second design guides,

Rd₁=289.55 nm, θ₁=7.50°,

Rd₂=281.02 nm, θ₂=34.43°, and

Rd₃=143.82 nm, θ₃=98.84°,

the transmitted light becomes circular polarization with ellipticity of substantially 1 when light of linear polarization (a polarization azimuth angle of 0°) parallel to the X axis of λ₁=405 nm, λ₂=660 nm and λ₃=780 nm enters the phase difference element 1. The contents in which a polarization state of the transmitted light and a polarization state of the light entering each of the phase difference layers of this phase difference element are described by the Stokes parameters are shown in Table 2. Also, it is found that Rd₁/Rd₃=2.01 is satisfied and is the condition based on the third design guide described above.

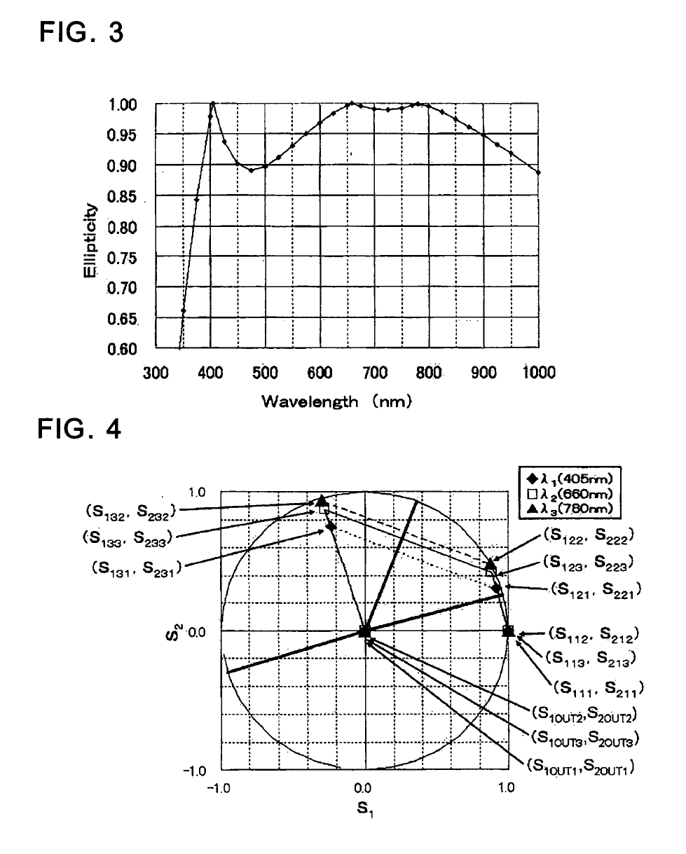

FIG. 3 shows a graph of ellipticity of light transmitted through the phase difference element 1 in a predetermined wavelength range on the above condition. This reveals that ellipticity of the transmitted light has peaks at three wavelengths of λ₁ (=405 nm), λ₂ (=660 nm) and λ₃ (=780 nm) and the ellipticity becomes high. By adjusting optic axis angles and retardations of three phase difference layers thus, it can be constructed so as to have the peaks at which ellipticity approximates to 1 at three design wavelengths, and it is shown that the phase difference element 1 capable of converting light of linear polarization into circular polarization with high accuracy can be implemented.

Also, when a semiconductor laser is used as a light source of an optical head apparatus actually, there are variations in a wavelength by individual difference of the semiconductor laser or a change in a wavelength occurs by a change in temperature of the semiconductor laser. These variations in the wavelength are about ±3% of the design wavelengths (λ₁, λ₂ and λ₃) (for example, 660 nm±20 nm). Therefore, as characteristics of the phase difference element 1, ellipticity approximates to 1 at only the design wavelengths λₖ and in addition, ellipticity of a wavelength band at the time of Δλₖ=3% is 0.6 or more at a wavelength band of λₖ±Δλₖ and thereby, it functions sufficiently for variations or a change in temperature of a light source wavelength and light use efficiency of the optical head apparatus can be maintained high. Further, it is more preferable that the ellipticity of the wavelength band at the time of Δλₖ=3% be 0.7 or more.

Further, when ellipticity of the phase difference element changes greatly in the case where a wavelength of a light source changes by temperature variations etc. at the time of Δλₖ=3% at a wavelength band of λₖ±Δλₖ, particularly in an optical head apparatus using an optical element such as a polarization beam splitter in which transmissivity depends on a polarization state, the amount of light reaching an optical disk or signal intensity from the optical disk changes by temperature and this is not preferable. As a result of that, a change in ellipticity is preferably small with respect to a change in a wavelength within the wavelength range described above. Concretely, when a wavelength changes by ±1% in the case of Δλₖ=3% at the wavelength band of λₖ±Δλₖ, the amount of change in ellipticity (difference between the maximum value and the minimum value in ellipticity) is preferably 0.1 or less, and more preferably 0.05 or less, and furthermore preferably 0.03 or less. In the present design example, 0.03 or less is achieved. When retardation Rd (=Δn·d) is large in the phase difference layer, a phase difference (|a phase of the fast axis−a phase of the slow axis|) of the transmitted light expressed by Δn·d·(2π/λ) also becomes large. In the case of assuming a change (λ±Δλ) in a wavelength in the vicinity of an incident wavelength λ, when retardation is large, a change in a phase difference also becomes large with respect to the change in the wavelength and dependence on the amount of change in the wavelength of ellipticity also becomes large.

From this, it could be designed so as to form the phase difference layers so that the following become 2 or less and more preferably 1 or less, 0.7 or less and furthermore preferably 0.5 or less in order to decrease a change in ellipticity in the vicinity of the design wavelengths (λ₁, λ₂ and λ₃: λ₁<λ₂<λ₃).

Rd₁₃/λ₃,

Rd₂₃/λ₃, and

Rd₃₃/λ₃.

In this first design example, the following are satisfied and all become 0.5 or less.

Rd₁₃/λ₃=289.55 nm/780 nm=0.37,

Rd₂₃/λ₃=281.02 nm/780 nm=0.36, and

Rd₃₃/λ₃=143.82 nm/780 nm=0.18.

Next, a method for doing design in consideration of wavelength dispersion of a material of a phase difference layer constructing the phase difference element 1 actually will be described. The wavelength dispersion of retardation of the phase difference layer varies depending on wavelength dispersion characteristics of a refractive index of a material. As the material of the phase difference layer, as described above, an optical anisotropic material having refractive index anisotropy is preferable, and an oriented organic material such as a polymer liquid crystal or a liquid crystal, a stretched organic film such as PVA, polyolefin or polycarbonate, a structural birefringence having a microstructure of a wavelength order, or a single crystal such as KTP, LiTaO₃, LiNbO₃ or a quartz crystal can be used. The phase difference layer is formed using these materials and the phase difference element is designed in consideration of wavelength dispersion characteristics of a refractive index.

When the polymer liquid crystal in which a liquid crystal is polymerized and becomes high molecules among the listed materials is used as a material for forming the phase difference layer, the phase difference layer can be manufactured at lower cost than that of formation by a single-crystal material and also a film of the phase difference layer is thinned or an optic axis can be formed in a plane perpendicular to an incident optical axis, so that it is preferable in an increase in design flexibility, for example, incidence angle dependence can be reduced. Here, the phase difference layer using the polymer liquid crystal will be described by way of example. In wavelength dependence (wavelength dispersion) of retardation of the polymer liquid crystal used herein, the phase difference layer in which ratios of each of the retardations of a wavelength λ₁=405 nm to wavelengths λ₂ (=660 nm) and λ₃ (=780 nm) are shown as follows is formed.

Rd(λ₂)/Rd(λ₁)=0.818, and

Rd(λ₃)/Rd(λ₁)=0.727.

(Second Design Example)

A second design example of adjusting an optic axis angle and retardation of each of the phase difference layers will be described based on the first, second and third design guides described above. In the present design example, both of Rd₁₁/Rd₃₁ and Rd₂₁/Rd₃₁ are set at 1.8 to 2.2. As a result of that, the following can be obtained with respect to incident light with a wavelength λ₁=405 nm.

Retardation Rd₁₁ of first phase difference layer 11=343.81 nm, Optic axis angle θ₁=9.54°,

Retardation Rd₂₁ of second phase difference layer 12=303.51 nm, Optic axis angle θ₂=34.58°, and

Retardation Rd₃₁ of third phase difference layer 13=166.25 nm, Optic axis angle θ₃=94.73°.

Values multiplied by the ratios of the retardations by the above design wavelengths are obtained with respect to λ₂ and λ₃.

Table 3 shows Stokes parameters indicating a polarization state in which light of these design wavelengths passes through each of the phase difference layers of the phase difference element and becomes light incident on the next layer.

TABLE 3

| | λ₁ (405 nm) | | | λ₂ (660 nm) | | | λ₃ (780 nm) | | |
|---|---|---|---|---|---|---|---|---|---|
| | S₁ | S₂ | S₃ | S₁ | S₂ | S₃ | S₁ | S₂ | S₃ |
| Light incident on first | 1.000 | 0.000 | 0.000 | 1.000 | 0.000 | 0.000 | 1.000 | 0.000 | 0.000 |
| phase difference layer | | | | | | | | | |
| Light incident on second | 0.955 | 0.129 | −0.266 | 0.797 | 0.585 | 0.146 | 0.848 | 0.438 | 0.297 |
| phase difference layer | | | | | | | | | |
| Light incident on third | −0.088 | 0.526 | −0.846 | −0.158 | 0.949 | 0.273 | −0.135 | 0.812 | 0.567 |
| phase difference layer | | | | | | | | | |
| Light transmitted through | 0.000 | 0.000 | 1.000 | 0.000 | 0.000 | 1.000 | 0.000 | 0.000 | 1.000 |
| phase difference element | | | | | | | | | |

Also, the second design example is designed so that ellipticity has a peak at each of the design wavelengths so that ellipticity approximates to 1 at the three design wavelengths λ₁, λ₂ and λ₃ like FIG. 3 showing ellipticity of light passing through the phase difference element 1 by light of a predetermined wavelength range (not shown). It is also apparent from Table 3 that a polarization state after passing through each of the phase difference layers goes through a different path at each of the wavelengths but a polarization state (1, 0, 0) of incident light changes to circular polarization with ellipticity=1 of (0, 0, 1) after passing through the element at each of the wavelengths. In addition, coordinates of the Stokes parameters in this second design example show values near to those of the first design example.

(Third Design Example)

Next, a third design example of the invention shows another example of combination of optic axis angles and retardations of three phase difference layers below. In addition, wavelength dispersion characteristics of each of the phase difference layers are the same as those of the second design example. The optic axis angle and retardation of each of the phase difference layers are adjusted based on the first, second and third design guides described above. In the present design example, Rd₂₁/Rd₁₁ is set at 1.5 to 2.5 and Rd₃₁/Rd₁₁ is set at 1.8 to 2.2. As a result of that, the following can be obtained with respect to incident light with a wavelength λ₁=405 nm.

Retardation Rd₁₁ of first phase difference layer 11=153.04 nm, Optic axis angle θ₁=38.83°,

Retardation Rd₂₁ of second phase difference layer 12=359.84 nm, Optic axis angle θ₂=89.55°, and

Retardation Rd₃₁ of third phase difference layer 13=322.94 nm, Optic axis angle θ₃=20.84°.

Similarly, values multiplied by ratios of retardations by the above design wavelengths are obtained with respect to λ₂ and λ₃.

Table 4 shows Stokes parameters indicating a polarization state in which light of these design wavelengths passes through each of the phase difference layers of the phase difference element and becomes light incident on the next layer.

TABLE 4

| | λ₁ (405 nm) | | | λ₂ (660 nm) | | | λ₃ (780 nm) | | |
|---|---|---|---|---|---|---|---|---|---|
| | S₁ | S₂ | S₃ | S₁ | S₂ | S₃ | S₁ | S₂ | S₃ |
| Light incident on first | 1.000 | 0.000 | 0.000 | 1.000 | 0.000 | 0.000 | 1.000 | 0.000 | 0.000 |
| phase difference layer | | | | | | | | | |
| Light incident on second | −0.641 | 0.359 | 0.678 | 0.399 | 0.132 | 0.908 | 0.646 | 0.077 | 0.759 |
| phase difference layer | | | | | | | | | |
| Light incident on third | −0.636 | 0.714 | 0.293 | 0.390 | −0.438 | −0.810 | 0.634 | −0.712 | −0.304 |
| phase difference layer | | | | | | | | | |
| Light transmitted through | 0.000 | 0.000 | 1.000 | 0.000 | 0.000 | 1.000 | 0.000 | 0.000 | 1.000 |
| phase difference element | | | | | | | | | |

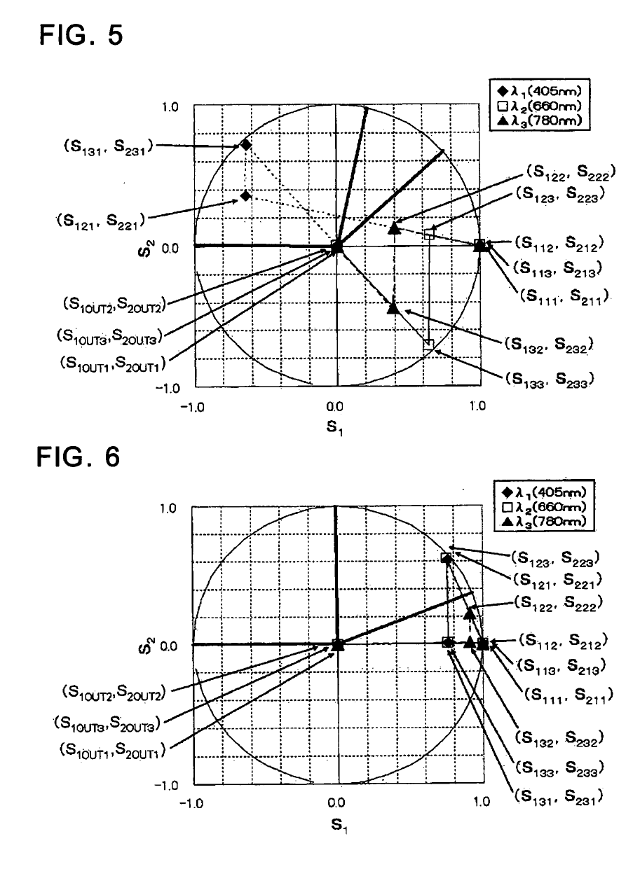

FIG. 5 shows two-dimensional space in which an S₁ component of the Stokes parameters shown in Table 4 is the axis of abscissa and an S₂ component is the axis of ordinate. In FIG. 5, a polarization state of light incident on the second phase difference layer 12 and the third phase difference layer 13 is different from that of the first design example and the second design example. It is apparent that a polarization state after passing through each of the phase difference layers goes through a different path at each of the wavelengths but the Stokes parameters indicating a polarization state are changed from a polarization state (1, 0, 0) of incident light to circular polarization with ellipticity=1 of (0, 0, 1) after passing through the element at each of the wavelengths.

Also, the third design example is designed so that ellipticity has a peak at each of the design wavelengths so that ellipticity approximates to 1 at the three design wavelengths λ₁, λ₂ and λ₃ like FIG. 3 showing ellipticity of light passing through the phase difference element 1 by light of a predetermined wavelength range (not shown). In addition, the third design example is also the design example based on the design condition described above.

(Fourth Design Example)

Next, a fourth design example of the invention shows another example of combination of optic axis angles and retardations of three phase difference layers below. In addition, wavelength dispersion characteristics of each of the phase difference layers are the same as those of the second design example. The optic axis angle and retardation of each of the phase difference layers are adjusted based on the first, second and third design guides described above. In the present design example, Rd₁₁/Rd₂₁ is set at 1.8 to 2.2 and Rd₂₁/Rd₃₁ is set at 1.5 to 2.5. As a result of that, the following can be obtained with respect to incident light with a wavelength λ₁=405 nm.

Retardation Rd₁₁ of first phase difference layer 11=650.30 nm, Optic axis angle θ₁=10.84°,

Retardation Rd₂₁ of second phase difference layer 12=327.37 nm, Optic axis angle θ₂=90.05°, and

Retardation Rd₃₁ of third phase difference layer 13=147.13 nm, Optic axis angle θ₃=45.31°.

Similarly, values multiplied by ratios of retardations by the above design wavelengths are obtained with respect to λ₂ and λ₃.

Table 5 shows Stokes parameters indicating a polarization state in which light of these design wavelengths passes through each of the phase difference layers of the phase difference element and becomes light incident on the next layer.

TABLE 5

| | λ₁ (405 nm) | | | λ₂ (660 nm) | | | λ₃ (780 nm) | | |
|---|---|---|---|---|---|---|---|---|---|
| | S₁ | S₂ | S₃ | S₁ | S₂ | S₃ | S₁ | S₂ | S₃ |
| Light incident on first | 1.000 | 0.000 | 0.000 | 1.000 | 0.000 | 0.000 | 1.000 | 0.000 | 0.000 |
| phase difference layer | | | | | | | | | |
| Light incident on second | 0.756 | 0.614 | −0.228 | 0.911 | 0.225 | −0.347 | 0.754 | 0.618 | −0.221 |
| phase difference layer | | | | | | | | | |
| Light incident on third | 0.757 | 0.008 | −0.653 | 0.911 | 0.010 | 0.412 | 0.755 | 0.008 | 0.655 |
| phase difference layer | | | | | | | | | |
| Light transmitted through | 0.000 | 0.000 | 1.000 | 0.000 | 0.000 | 1.000 | 0.000 | 0.000 | 1.000 |
| phase difference element | | | | | | | | | |

FIG. 6 shows two-dimensional space in which an S₁ component of the Stokes parameters shown in Table 5 is the axis of abscissa and an S₂ component is the axis of ordinate. In FIG. 6, a polarization state of light incident on the second phase difference layer 12 and the third phase difference layer 13 goes through a different path, but it is apparent that the Stokes parameters indicating a polarization state are changed from a polarization state (1, 0, 0) of incident light to circular polarization with ellipticity=1 of (0, 0, 1) after passing through the element at each of the wavelengths.

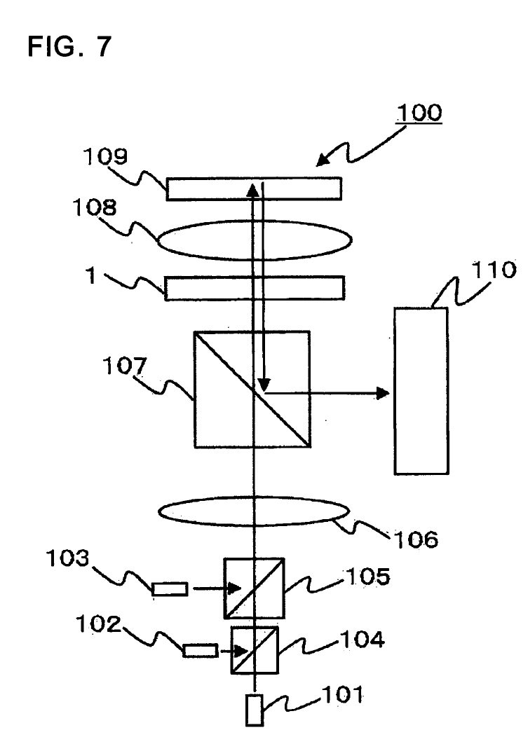

Next, an example of adapting a phase difference element of the invention to an optical head apparatus will be described. FIG. 7 is one example of a schematic diagram of an optical head apparatus according to the invention. Light of respectively different wavelengths emitted from three semiconductor laser light sources 101, 102, 103 is combined by wave combination prisms 104, 105 and passes through a collimator lens 106 and passes through a polarization beam splitter 107 and passes through the phase difference element 1 of the invention and is collected in an optical disk 109 by an objective lens 108. The collected light again passes through the objective lens 108, the phase difference element 1, etc. and is reflected by the polarization beam splitter 107 and is guided to an optical detection system 110 and information about the optical disk can be read.

Here, as shown in FIG. 7, in a semiconductor laser, three lasers with a band of 405 nm, a band of 660 nm and a band of 790 nm may be used individually, or the so-called twin laser for emitting light of two different wavelengths from one semiconductor laser or a triple laser for emitting three different wavelengths may be used. Also, use of laser light of four or more different wavelengths is not prevented. Regardless of arrangement shown in FIG. 7, the phase difference element 1 could be arranged in an optical path common to light of three different wavelengths. In the phase difference element 1, three phase difference layers are respectively made of a polymer liquid crystal and as an optic axis angle or retardation of each of the layers, those of the second design example are used. These phase difference layers are respectively manufactured on three glass substrates and they are laminated an integrated and thereby, manufacture can be performed.

Light of linear polarization of an outgoing path toward the optical disk 109 and emitted from the light sources 101, 102, 103 is converted into light of circular polarization with ellipticity of substantially 1 in all the light of three different wavelengths by passing through the phase difference element 1 of the invention. By passing through the phase difference element 1 of the invention again after the light is reflected by the optical disk 109, the light becomes light of linear polarization orthogonal to a polarization direction of the outgoing path and is reflected by the polarization beam splitter 107 in a direction guided to the optical detection system 110 efficiently. Thus, by using the phase difference element 1 of the invention, change to light of circular polarization can be made in the outgoing path and conversion to light of linear polarization orthogonal to the outgoing path can be made in an incoming path at the three different wavelengths.

### INDUSTRIAL APPLICABILITY

A phase difference element according to the invention has characteristics for giving a peak at which ellipticity is approximated to 1 to light of linear polarization of three or more different wavelengths. Also, use for an optical disk with different standards for making reproduction and recording can be made by equipping an optical head apparatus for emitting light of three different wavelengths with this phase difference element.

1. A phase difference element for changing a polarization state of incident light incident by light of linear polarization of three or more different wavelengths λₖ (k=1, 2, 3, . . . ) and transmitting the light, the phase difference element comprising:
a first phase difference layer;
a second phase difference layer; and
a third phase difference layer, wherein:
the first phase difference layer, the second phase difference layer and the third phase difference layer are respectively arranged in parallel, and have refractive index anisotropy from the incident light side;
a fast axis direction of the second phase difference layer differs from fast axis directions of the first phase difference layer and the third phase difference layer;
ellipticity of light transmitted through the phase difference element changes by a wavelength of the transmitted light; and
retardations of the respective three phase difference layers and angles of optic axis directions of the respective three phase difference layers are adjusted so that peaks at which the ellipticity approximates to 1 are had at the three or more wavelengths and ellipticity at a wavelength band of λₖ±Δλₖ at the time of setting Δλₖ at 3% of the wavelength λₖ becomes 0.6 or more.

2. A phase difference element according to claim 1, wherein
light of linear polarization of three different wavelengths λₖ (k=1, 2, 3) enters the phase difference element and peaks at which the ellipticity approximates to 1 are had at the three different wavelengths and also the amount of change in ellipticity at the time when a wavelength changes by 1% is within 0.1 at a wavelength band of λₖ±Δλₖ at the time of setting Δλₖ at 3% of the wavelength λₖ.

3. A phase difference element according to claim 1, wherein
when light of the three wavelengths λ₁, λ₂ and λ₃ is entered by light of linear polarization becoming the same polarization direction and values of Stokes parameters indicating a polarization state of light incident on the third phase difference layer are respectively set at (S₁₃₁, S₂₃₁, S₃₃₁), (S₁₃₂, S₂₃₂, S₃₃₂) and (S₁₃₃, S₂₃₃, S₃₃₃) with respect to the three wavelengths λ₁, λ₂ and λ₃, values of B₁, B₂ and B₃ satisfying the following equalities are substantially equal.
S₂₃₁=B₁×S₁₃₁,
S₂₃₂=B₂×S₁₃₂, and
S₂₃₃=B₃×S₁₃₃.

4. A phase difference element according to claim 1, wherein
when light of the three wavelengths λ₁, λ₂ and λ₃ is entered by light of linear polarization becoming the same polarization direction and values of Stokes parameters indicating a polarization state of light incident on the second phase difference layer are respectively set at (S₁₂₁, S₂₂₁, S₃₂₁), (S₁₂₂, S₂₂₂, S₃₂₂) and (S₁₂₃, S₂₂₃, S₃₂₃) with respect to the three wavelengths λ₁, λ₂ and λ₃, values of A₁, A₂ and A₃ satisfying the following equalities are substantially equal.
(S₂₃₁−S₂₂₁)=A₁×(S₁₃₁−S₁₂₁),
(S₂₃₂−S₂₂₂)=A₂×(S₁₃₂−S₁₂₂), and
(S₂₃₃−S₂₂₃)=A₃×(S₁₃₃−S₁₂₃).

5. A phase difference element according to claim 1, wherein
the λ₁ is between 380 and 450 nm and the λ₂ is between 600 and 720 nm and the λ₃ is between 750 and 900 nm.

6. A phase difference element a according to claim 1, wherein
ellipticities of the transmitted light in which light of the three wavelengths λ₁, λ₂ and λ₃ is transmitted through the phase difference element are respectively 0.9 or more.

7. An optical head apparatus comprising:
a light source with three different wavelengths;
an objective lens for collecting light emitted from the light source in an optical disk;
an optical detector for detecting reflected light from the optical disk; and
a phase difference element according to claim 1, arranged in an optical path ranging from a light source to an optical detector.
